(19) United States
(12) Patent Application Publication
(10) Pub. No.: US 2009/0024985 A1
(43) Pub. Date: Jan. 22, 2009

(54) TASK CONTROL METHOD AND SEMICONDUCTOR INTEGRATED CIRCUIT

(75) Inventors: TETSURO HOMMURA, Sagamihara (JP); Satoshi Misaka, Kokubunji (JP); Hiroyuki Ono, Hachioji (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/174,711

(22) Filed: Jul. 17, 2008

(30) Foreign Application Priority Data
Jul. 18, 2007 (JP) 2007-186709

(51) Int. Cl. G06F 9/44

(52) U.S. Cl. 717/129

(57) ABSTRACT

A task control method by which when a multiprocessor device having processors executes application software tasks, checkpoints have been buried in the application software tasks in advance. In course of execution of each application software task, the checkpoints are used to make an inquiry about passed one of the checkpoints in the task. Then, the progress of each task is judged based on the current passed checkpoint identified as a result of the inquiry and a passed budget corresponding to the passed checkpoint. Based on a result of the judgment, a resource shared by the tasks is controlled, and a new passed budget is set. Thus, the restriction on the scope of application of an application software program is reduced.

### CLAIM OF PRIORITY

The Present application claims priority from Japanese application JP-2007-186709 filed on Jul. 18, 2007, the content of which is hereby incorporated by reference into this application.

### FIELD OF THE INVENTION

The present invention relates to a task control technique used when a processor executes an application software task.

### BACKGROUND OF THE INVENTION

As for semiconductor integrated circuits, the limits of rise in clock frequency arising with the progress of miniaturization, and the increase in power consumption make more and more difficult to achieve speedup of processing and reduction in power consumption. Hence, fine control of tasks and hardware resources taking into account not only a hardware resource and a method for executing each task, which have been decided statically before execution of the task heretofore, but also a dynamically decided factor has been in the spotlight.

Taking a typical example thereof, JP-A-2002-202893 discloses a technique including making a judgment of the progress of a task which repeatedly executes same program based on the number of program runs. Specifically, the program has a budget time T, and if it is run repeatedly M times in total, the program will be run M times for the time, T multiplied by M. Actually, in this case, if the number of times the program is run is below M, the processing is judged to be slow; if the number is above M, it is judged to be fast. The clock frequency may be raised when it is delayed remarkably, and it may be lowered when it is in advance.

The control which JP-A-2002-202893 targets is for reduction in electric power consumption, and the description is presented assuming the case of lowering the clock frequency. However, this is no different from the way of raising the frequency when the processing is delayed essentially. With the conventional technique like this, the progress is judged based on the number of times that a predetermined program is run repeatedly, and the clock frequency and voltage are controlled based on the result of the judgment, whereby the integrated circuits are improved in performance and power consumption.

### SUMMARY OF THE INVENTION

The conventional technique as described above is restricted in the scope of application of an application software program because the progress is judged on the number of times that a certain program is run. For example, when a task is constituted by a combination of programs different in run time, it cannot serve the need for change in frequency on an individual program basis.

An image compression program includes subprograms of discrete cosine transform (DCT), variable length coding, and quantization, and the subprograms have different run times. Therefore, in order to perform control more quickly when the whole image compression program is repeated N times, it is desired to control while monitoring the progress in an individual program basis.

In addition, the conventional technique does not deal with a task on a multiprocessor, and there is no disclosure concerning the control of a resource shared by processors.

Further, from the viewpoint of increase in control efficiency, when control which must be performed on a single processor is separated from the control over a shared resource, the volume of processor traffic and the overhead can be reduced. However, with the conventional technique which does not target a multiprocessor, there is no suggestion about this method.

Hence, it is an object of the invention to provide a technique to ease the restrictions on the scope of application of an application software program targeted for task control.

The above and other objects and novel features hereof will be apparent from the description hereof and the accompanying drawings.

Of embodiments disclosed herein, the preferred ones will be described below briefly.

When a multiprocessor device having processors executes application software tasks, checkpoints have been buried in the application software tasks in advance. In course of execution of each application software task, the checkpoints are used to make an inquiry about passed one of the checkpoints in the task. Then, the progress of each task is judged based on the current passed checkpoint identified as a result of the inquiry and a passed budget corresponding to the passed checkpoint. Based on a result of the judgment, a resource shared by the tasks is controlled, and a new passed budget is set. Thus, the restriction on the scope of application of an application software program is eliminated.

### BRIEF DESCRIPTION OF THE DRAWINGS

FIG. 1 is a block diagram showing an example of the configuration of a multiprocessor, on which a method for controlling a task in association with the invention is conducted;

FIG. 2 is a diagram showing the operation sequence of the operation of grasping the progress of processing the task and the operation of controlling execution of the task in the multiprocessor;

FIG. 3 is a diagram for explaining the available budget for the multiprocessor and its update;

FIG. 4 is a flowchart of an example of the operation of setting checkpoints in an application software in the multiprocessor;

FIG. 5 is an illustration showing a registration table of checkpoint budget time used by a local resource controller (LRCL) in the multiprocessor;

FIG. 6A is an illustration showing a passing-of-checkpoint registration table (Elapsedtime-RT 600);

FIG. 6B is an illustration showing the flow of the registration process of passing the point for a checkpoint CPn;

FIG. 7 is a flowchart of the operation of the local resource controller (LRCL) in the multiprocessor;

FIG. 8A is an illustration showing information of which the LRCL notifies a shared-resource control module (CRM) in the multiprocessor;

FIG. 8B is an illustration showing the relation between the checkpoint and elapsed time, which are in association with the information of which the LRCL notifies the CRM in the multiprocessor;

FIG. 9 is a flowchart of the operation of the CRCL in the multiprocessor;

FIG. 10 is a block diagram showing an example of the configuration of a simulator in connection with the invention;

FIG. 11 is a flowchart of the operation of the simulator;

FIG. 12 is an illustration of assistance in explaining task control when two processors of the multiprocessor are different from each other in processor time;

FIG. 13 is an illustration of assistance in explaining other task control when the two processors are different from each other in processor time; and

FIG. 14 is an illustration of assistance in explaining other task control when he two processors are different from each other in processor time.

### DETAILED DESCRIPTION OF THE PREFERRED EMBODIMENTS

### 1. Summary of the Preferred Embodiments

First, the preferred embodiments of the invention herein disclosed will be described in brief outline. Here, the reference numerals, characters or signs for reference to the drawings, which are accompanied with paired round brackets, only exemplify what the concepts of components referred to by the numerals, characters or signs contain.

[1] According to the first embodiment, in a task control method, when a multiprocessor device having processors (100, 101) executes application software tasks, checkpoints have been buried in the application software tasks in advance. In course of execution of each application software task, the checkpoints are used to make an inquiry about passed one of the checkpoints in the task. Then, the progress of each task is judged based on the current passed checkpoint identified as a result of the inquiry and a passed budget corresponding to the passed checkpoint. Based on a result of the judgment, a resource shared by the tasks is controlled, and a new passed budget is set.

[2] According to the second embodiment, in the task control method, the inquiry addressed to each application software task is made at the time when an estimated elapsed time of a certain checkpoint elapses. The information notified as a result of the inquiry includes information of the checkpoint which the task is currently passing, and information of time of passing the checkpoint.

[3] According to the third embodiment, in the task control method, when the task larger in degree of delay than the other tasks is controlled, the tasks are separated into a part for controlling a parameter used only by predetermined one of the processors and a part for controlling a resource shared by more than one processor, and the predetermined processor performs task control on the part for controlling the parameter, and a module independent of the more than one processor performs control on the part for controlling the shared resource.

[4] According to the fourth embodiment, in the task control method, the judgment of progress is performed using a budget value (e.g., budget time) (7104) of elapsed time which has elapsed before termination of each task, a budget value (7106) of elapsed time of the just passed checkpoint, and an actual elapsed time (7105) of the just passed checkpoint.

[5] According to the fifth embodiment, as to the task control method in connection with the third embodiment, the task control performed by the predetermined processor may include transferring a budget value of elapsed time which has elapsed before termination of each task, a budget value of elapsed time of the just passed checkpoint and an actual elapsed time of the just passed checkpoint to the module which performs control on the shared resource together with a processor ID and new resource information created as a result of controlling a local resource.

[6] According to the sixth embodiment, the task control method in connection with the third embodiment may include the step of changing a priority of the task in association with the shared resource or the processor with the task loaded thereon so that the priority of the task more difficult to make up for delay or the processor with the task loaded thereon is made higher.

[7] According to the seventh embodiment, the task control method in connection with the third embodiment may include, as a means for making higher the priority of the task more difficult to make up for delay or the processor with the task loaded thereon, the step of making higher the priority of the task higher in ratios of B to A and C to B or the priority of the processor with the task loaded thereon, where A denotes a budget value of elapsed time which has elapsed before termination of each task, B denotes a budget value of elapsed time of the just passed checkpoint, and C denotes an actual elapsed time of the just passed checkpoint.

[8] According to the eighth embodiment, a semiconductor integrated circuit which includes a memory (106) storing a task control program for realizing the task control method, and CPUs (100, 101) which can run the task control program stored in the memory can be arranged.

### 2. Further Detailed Description of the Preferred Embodiments

Next, the further detailed description of the embodiments will be presented. Best modes for embodying the invention will be described below in detail with reference to the drawings. Now, it is noted that in all the drawings referred to in describing the best modes for embodying the invention, members having identical functions are identified by the same reference numeral or character, and the iteration of the description is avoided.

### <Configuration of Multiprocessor System>

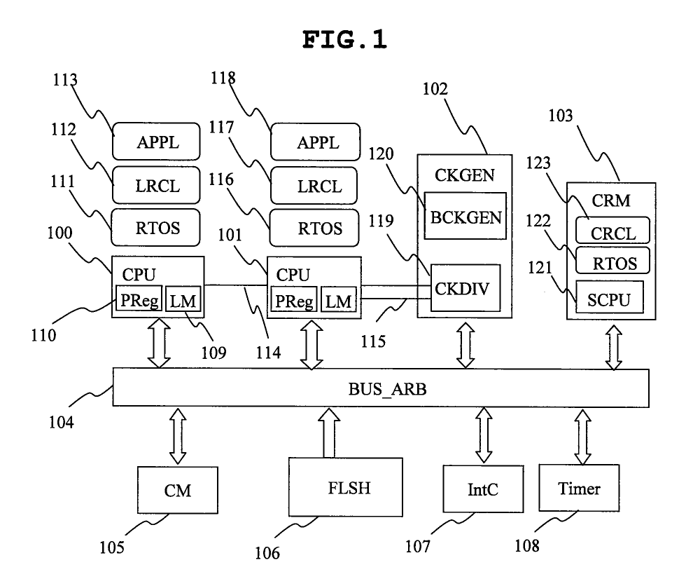

FIG. 1 shows a multiprocessor system as an example of the semiconductor integrated circuit in association with the invention. The multiprocessor system shown in FIG. 1 is not particularly limited, however it is formed on a single semiconductor substrate such as a monocrystalline silicon substrate by a publicly known semiconductor integrated circuit manufacturing technique. In FIG. 1, a rectangle represents a hardware component, and a rectangle with corners rounded represents an OS (Operating System) or a kind of software program such as a task.

While the multiprocessor system is not particularly limited, it includes: two general-purpose processors (CPUs) 100 and 101; a clock generator circuit (CKGEN) 102; a shared-resource management module (CRM) 103; buses; and a bus arbitration circuit (BUS_ARB) 104 for performing arbitration of the buses; a shared memory (CM) 105 shared by the processors; a flash memory (FLSH) 106 for storing various kinds of software programs to be loaded into the processors at the time of boot; an interrupt controller (IntC) 107 used in executing a various kinds of service calls by real-time operating systems (RTOS) 111 and 116; and a timer (Timer) 108. Also, in the flash memory (FLSH) 106, a task control program for realizing the task control method in this example is stored.

The CPU 100 incorporates a local memory (LM) 109 and a priority register (PReg) 110. The LM 109 is used to store an intermediate result produced during processing by the CPU 100. The PReg 110 is used to store the priorities to access to the BUS_ARB 104.

The software to be installed to the CPU 100 includes: a real-time operating system (RTOS) 111; a local resource controller (LRCL) 112 for controlling a parameter such as a clock frequency relevant to only the CPU 100; and an application task (APPL) 113. Likewise, the software to be installed to the CPU 101 includes: a real-time operating system (RTOS) 116; a program LRCL 117; and an application task (APPL) 118.

The clock generator circuit (CKGEN) 102 inclues: a basic-clock generator circuit (BCKGEN) 120 having a quartz oscillator which produces a basic clock commonly used in the multiprocessor; and a frequency-divider circuit (CKDIV) 119 which performs frequency division based on the basic clock to produce a clock for each CPU. The BCKGEN 120 is controlled by the CRM 103 through the BUS_ARB 104. The CKDIV 119 is controlled by the CPUs 100 and 101 through control signals and clock-division signals 114 and 115 from the CPUs, or controlled by the CRM 103 through the BUS_ARB 104, and it distributes clocks.

The CRM 103 includes: a SCPU 121, which is a CPU exclusively for a shared-resource controller; and a real-time operating system (RTOS) 122 and a shared-resource controller (CRCL) 123, both loaded on the SCPU 121. As for the BUS_ARB 104, it is possible to set the priority to use a bus of the circuit can be set through the CRM 103, which is to be described later.

### <Control Flow in the Multiprocessor System>

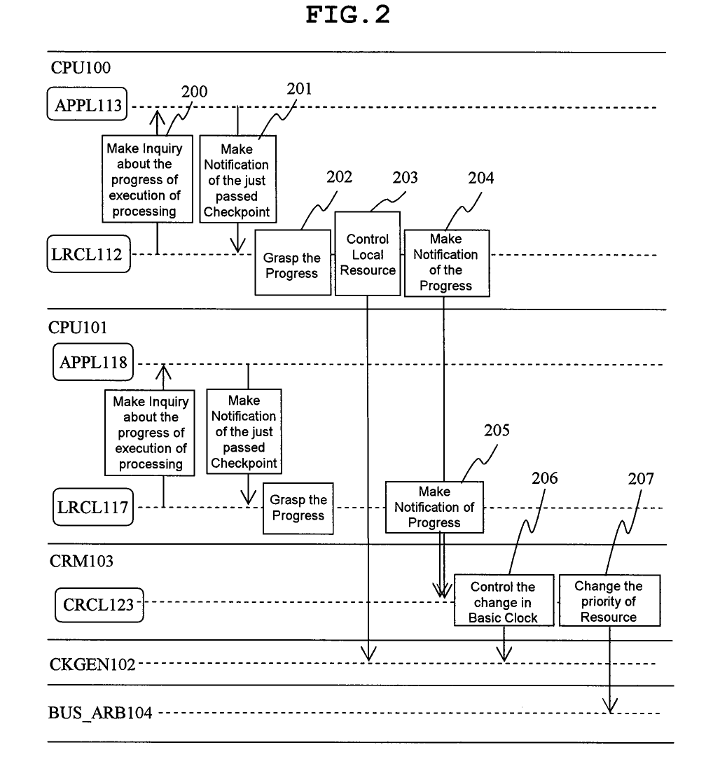

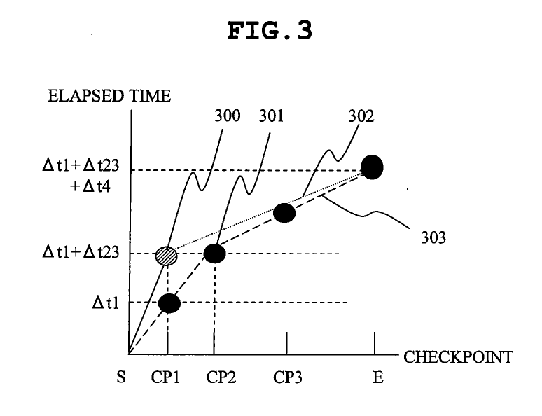

Now, referring to FIGS. 2 and 3, the control flow in the multiprocessor system will be described.

The uppermost or first portion of FIG. 2 for the CPU 100 shows the flow of processing by the local resource controller LRCL 112; the third portion of FIG. 2 for the CRM 103 shows the flow of processing by the shared-resource controller CRCL 123.

First, the local resource controller (LRCL) 112 makes an inquiry about the progress of execution of the processing at the budget elapsed time of a certain checkpoint of the APPL 113 (Step 200), and receives notification of the just passed checkpoint (Step 201).

Checkpoints have been buried in the APPL 113 in advance, and a budget, i.e. budget elapsed time has been determined for each checkpoint in advance as shown by a broken line representing the prior budget 303 in FIG. 3. Now, in the drawing, the reference character S denotes Start, and E denotes End, symbolizing special forms of checkpoints. For example, in FIG. 3, it is clear that the budget elapsed time of the checkpoint CP2 is Δt1+Δt23, as shown by the numeral 301. When an inquiry about the progress of execution of processing is made at this time (Step 200), it is found that only the checkpoint CP1 has been passed (Step 201). In other words, the point denoted by the numeral 300 represents the latest situation of checkpoint passing. On Receipt of the result of this, the local resource controller (LRCL) 112 grasps the extent of seriousness of the delay and the progress from the comparison between the rest of time until the end and the remaining amount of processing (Step 202).

Next, on receipt of the progress, the LRCL 112 controls a local resource exclusively for the CPU 100 in order to make up for the delay (Step 203). For example, at time Step 203, the LRCL 112 changes the clock for the CPU 100. Specifically, the LRCL 112 changes the frequency multiplication ratio of the CKDIV 119 in the clock generator circuit (CKGEN) 102 through the signal 114 as shown in FIG. 1 thereby to change the clock frequency for the CPU 100.

In parallel, the LRCL 112 notifies the CRM 103 of the progress for control of the shared resource (Step 204).

The CPU 101 works the same as the CPU 100. The shared-resource controller (CRCL) 123 of the CRM 103 receives notifications of the progress from the CPUs 100 and 101 (Steps 204 and 205), and controls the shared resource. When it is necessary to change the basic clock, the clock generator circuit CKGEN102 is controlled as shown by Step 206. In addition, the CRCL 123 compares the CPU 100 with the CPU 101 in progress, and raises the priority of the shared resource in connection with the processor delayed more remarkably as shown by Step 207. In the block diagram of FIG. 1, the BUS_ARB 104 corresponds to the shared resource, and therefore the control to change the priority of the bus arbitration circuit BUS_ARB 104 is performed.

The dotted line 302 in FIG. 3 shows the new budget of elapsed time set as a result of the processing by the local resource controller (LRCL) 112 and the CRCL 123, which corresponds to the prior budget 303 revised and held.

### <Checkpoint in Application Software>

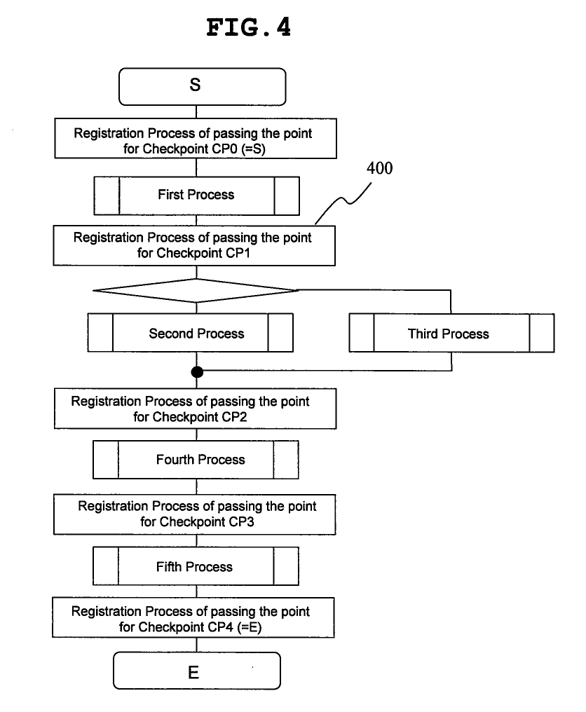

Now, an example of checkpoints to be contained in an application software, a budget time registration table to register the prior budget 303 in, and a registration process of passing the point, which is carried out at the time of passing each checkpoint, will be described with reference to FIGS. 4 to 6. To conduct a combination of processes of Steps 200 and 201, it is necessary to execute the registration process of passing the point on the application software side in advance.

The point where the checkpoint registration process 400 of passing the point is performed, as shown in FIG. 4, makes a checkpoint. In this example, five checkpoints CP0 to CP4 are set. The checkpoint CP0 is starting one, and CP4 is end one, which are also denoted by the symbols Sand E respectively.

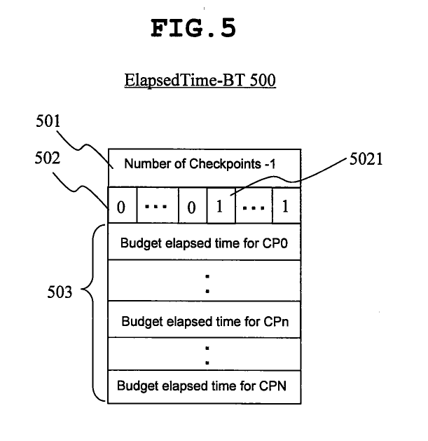

As to these checkpoints, each budget elapsed time is registered in the budget elapsed time registration table (ElapsedTime-BT 500) previously as shown in FIG. 5. As in FIG. 5, in the area 501, N which represents the number of checkpoints minus one is registered; in the area 503, budget elapsed times of the checkpoints CP0 to CPN are registered. The area 502 is the one which the local resource controller (LRCL) 112 marks for the checkpoint which has been passed actually. Initially, all the bits are zero. However, for the bit corresponding to the checkpoint which has been passed, a flag of “1” is set. In the case shown by FIG. 5, if the bit indicated by the numeral 5021 is the one numbered n, it is shown that the checkpoints of up to CPn have been passed.

Now, the registration process of passing the point for the checkpoint CPn will be described.

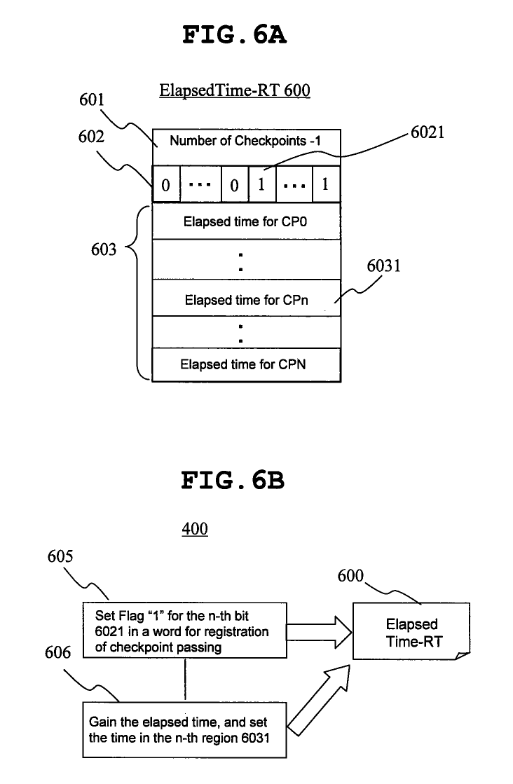

FIG. 6A shows a passing-of-checkpoint registration table (ElapsedTime-RT 600). FIG. 6B shows the flow of the registration process of passing the point for the checkpoint CPn.

How the areas shown in FIG. 6A serve is substantially the same as those shown in FIG. 5, however they are different only in data registered in the area 603 is the time when the checkpoint CPn is passed actually. The areas 601 and 602 are the same in function as the areas 501 and 502 respectively. In the registration process of passing the point as shown in FIG. 6B, in Step 605 the flag “1” is set for the bit denoted by the numeral 6021, which is the n-th bit in the area 602, and the elapsed time is registered in the area denoted by the numeral 6031, which is the n-th area in the area 603. Now, it is noted that the elapsed time can be obtained from the Timer 108 after time is reset to zero at a time-initialization point. Usually, API for a timer is defined by each real-time operating system RTOS, and time can be gained through the API.

### <Local Resource Controller (LRCL)>

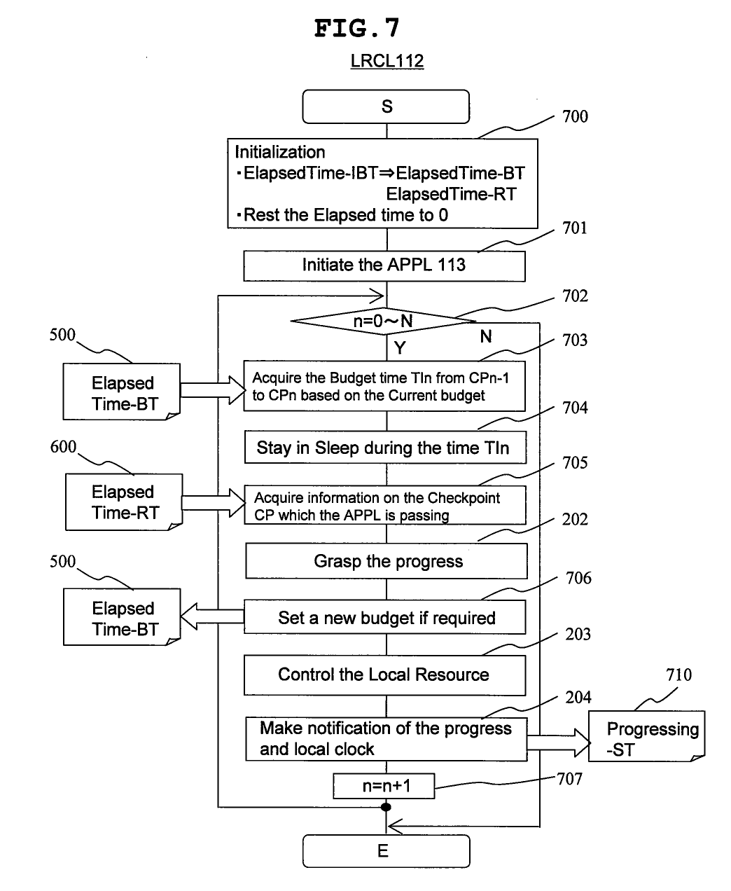

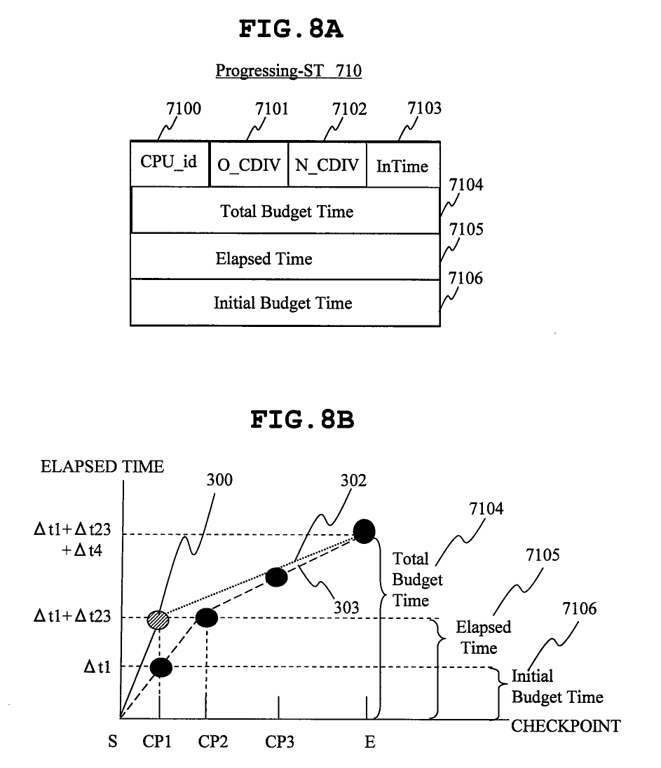

Here, the flow of processing by the LRCL 112 will be described with reference to FIGS. 7, 8A and 8B.

The local resource controller LRCL 112 is a task which works constantly while the CPU is in operation. The flow shown in FIG. 7 is based on the assumption that only one application task needs to be managed. Therefore, when there are two or more application tasks which require managing, the processing is repeated two or more times.

First, in Step 700 tables for elapsed time management and elapsed time are initialized. The tables are ElapsedTime-BT 500 and ElapsedTime-RT 600. The initial budget table ElapsedTime-IBT, which has been registered in advance, is copied into the two tables.

Second, in Step 701 the APPL 113 is initiated.

The processes after Step 702 constitute a main portion of the processing.

The process of Step 702 is judgment by a loop counter. The processes of Steps 703 to 707 are ones relating to a checkpoint CPn, making a loop. After in Step 707 the number n is incremented by one, the loop of processes is carried out on a subsequent checkpoint. In this way, the loop of processes is repeated from n=0 to N. Now, it is noted that this loop can indicate the progress of passing the checkpoint, and when the number of iterations of the loop is regarded as an index, the operation can be also materialized by the prior art substantially in the same way.

A combination of the processes of Steps 703 and 704 makes a preparation process, in which an inquiry on the progress of execution of processing is made. In Step 703, the budget elapsed time from the current checkpoint CPn−1 to the subsequent one CPn is acquired from the ElapsedTime-BT 500. In Step 704, the application task APPL113 stays in Sleep during the elapsed time.

In Step 705, a datum about the checkpoint which the processing by the APPL 113 is actually passing at present is acquired from the ElapsedTime-RT 600 when the value of the timer reaches an estimated passing time. This process corresponds to the combination of processes of Steps 200 and 201 as shown in FIG. 2. In this example, as the application task has been subjected to registration of checkpoints previously, the inquiry of Step 200 corresponds to reading out of the ElapsedTime-RT 600, and the notification of Step 201 corresponds to acquisition of datum, i.e. the datum of the passed checkpoint. The combination of processes of Steps 200 and 201 may be realized following the writings faithfully through message communication between tasks using service call by OS.

In Step 202, the local resource controller judges the degree of delay based on the budget elapsed time of the just passed checkpoint and the budget time for which all the processes are completed. In this example, the ratio of the actual elapsed time 7105 with respect to the Initial Budget Time 7106 is used as an index to judge the degree of delay (see FIGS. 8A and 8B).

In Step 706, when the degree of delay, on which a judgment has been made in Step 202, exceeds a predetermined threshold, a new budget is set. Then, in step 203, control of a local resource required to realize the new budget is performed. In this example, only a local clock, which can be set for each CPU, is taken as the local resource. The frequency-divider circuit CKDIV119 is used to change the frequency multiplication ratio of the clock as stated above.

The CPU 100 notifies the CRM 103 of the progress and the local clock using the Progressing-ST 710, which is a situation table (Step 204).

Now, the Progressing-St 710 will be described in detail.

In FIG. 8A, the numerals 7101 to 7103 denote information pieces in association with local clocks. The frequencies of the local clocks can be expressed by the old frequency multiplication ratio (O_CDIV) 7101 and new frequency multiplication ratio (N_CDIV) 7102 belonging to the CPU-id 7100. As it is assumed that the CRM 103 holds the basic clock BCK, the former and new frequencies can be calculated from the two parameters. The InTime 7103 shows whether or not the deadline of termination of the task can be achieved by the new budget 302 as shown in FIG. 8B after the change to the new frequency multiplication ratio (N_CDIV) 7102. The flag “1” means that the deadline can be achieved, whereas “0” means that the deadline cannot be achieved. When the deadline cannot be achieved, the CRM 103 conducts examination on the change in the basic clock. The numerals 7104 to 7106 denote information pieces for judging the progress of the task on the CPU-id. This will be described with reference to FIG. 8B.

In this example, it is assumed that only one task is running on each CPU. However, even when more than one task works, the portions as denoted by the numerals 7104 to 7106 prepared corresponding to the number of the tasks can cope with such situation. Total Budget Time 7104 shows an estimated time at which the task will be finished as shown in FIG. 8B. In other words, Total Budget Time 7104 shows a deadline of the elapsed time. Elapsed Time 7105 is the elapsed time of the checkpoint CP1, which the current condition denoted by the numeral 300 shows. Initial Budget Time 7106 shows the budget time at which the point denoted by the numeral 300 was supposed to pass the checkpoint CP1 originally. As described later, comparing the Initial Budget Time 7106 with the Total Budget Time 7104, the extent to which the task proceeds when viewed from the viewpoint of the amount of processing can be judged.

Now, a method using, as the information which enables the judgment on the progress, the number of cycles rather than the real time may be adopted. This method has the advantage that it is well compatible with a compiler. However, the method is poor in compatibility with OS, and when more than one clock is handled, some measures such as preparation of a common clock will be needed.

### <Shared-Resource Controller (CRCL)>

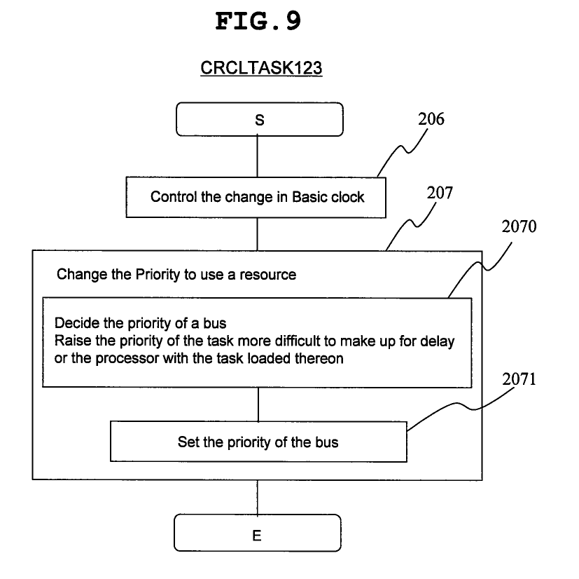

Next, the flow of processing by the CRCL 123 will be described with reference to FIG. 9.

The CRCL 123 has two functions. One of the functions includes controlling a shared resource to achieve a task budget in reality when only the control of the local resource by the local resource controller (LRCL) 112 cannot eliminate the difficulty in achieving the task budget. Another function includes changing access priorities of tasks loaded on different processors in the multiprocessor according to the degree of progress of the tasks when the tasks attempt to access a resource shared by the processors at a time. Specifically, the priority of the task more difficult to make up for delay, or the priority of the processor on which the task is loaded is raised. The former function is exercised in Step 206, and the latter one is exercised in Step 207. In Step 206, when the task has changed the local clock, however it is difficult to achieve the budget, i.e. when InTime 7103 shown in FIG. 8A is in OFF, the basic clock, which is a shared resource in this example, is raised thereby to enable achievement of the budget. The change of the frequency of the basic clock is conducted by controlling the basic clock generator circuit (BCKGEN) 120 through the BUS_ARB 104 as shown in FIG. 1.

The frequencies of local clocks for other CPUs are raised with an increase in the frequency of the basic clock. Therefore, to suppress the unwanted power consumption, the local clocks of the other CPUs are controlled so that the frequency multiplication ratios are increased thereby to prevent their frequencies from being made higher than necessary. This control is performed on the CKDIV 119 as shown in FIG. 1 through the BUS_ARB 104.

In Step 207, a process to change the priority to use the shared resource based on the data about the progress of the tasks sent from the processors is performed. In this example, as such shared resource is taken a bus in the BUS_ARB 104 as shown in FIG. 1.

First, in Step 2071, a decision to raise the priority of a bus for the task more difficult to make up for delay or the processor on which the task is loaded is raised is made. Next, the following two rules are adopted as criteria to make the judgment that it is difficult to make up for delay. In the case where two or more buses are identical in priority even when the Rule 1 is applied, the Rule 2 is applied to the case in question.

Rule 1

Priorities should be allocated in descending order according to the ratio of the progress of processing. It should be assumed that the larger the ratio of the processed amount of processing to the whole, the fewer the possibility of making up for delay and the more difficult to compensate such delay. One reason for this is that earlier termination can reduce the scheduling problems.

Rule 2

Priorities should be decided in descending order according to the degree of delay of tasks or processor with the tasks running thereon. This is because when a task with a larger delay is left as it is, it becomes more difficult to make up for the delay.

When the Rule 1 is applied, the values of Progressing-ST 710 are fitted into the following equation (i). At this time, the priority of the task larger in ratio of the progress thereof or the processor with the task loaded thereon is made higher because the larger “Progress Ratio”, the larger the ratio of the progress of processing.

Progress Ratio=Initial Budget Time 7106/Total Budget Time 7104 (i)

When the rule 2 is applied, the following equation (ii) is used. At this time, the priority of the task larger in “Degree of Delay” or the processor with the task loaded thereon is made higher because the larger the “Degree of Delay”, the more significant the delay with respect to the budget.

Degree of Delay=Elapsed Time 7105/Initial Budget Time 7106 (ii)

Subsequently, the value of a priority thus decided is set in a priority-setting register in the processor so that the priority can be output as a signal to the BUS_ARB 104 in Step 2071. For example, in CPU 100 the priority register (PReg) 110 as shown in FIG. 1 forms the priority-setting register. Each bit of the register is used as an input-control signal to BUS_ARB 104.

The effect and advantage which the embodiment can offer are as follows.

First, as the effect, two or more checkpoints to judge the progress are held in a program of an application task, and when a certain event occurs, an inquiry about the latest checkpoint which the application task has passed and the elapsed time is made, and based on the result of the inquiry, the progress of the task is judged by a control task. Then, the execution of the task is controlled based on the result of the judgment. When a task working on a processor is controlled, as the certain event is defined elapse of the estimated completion time at which the task is expected to pass a predetermined checkpoint. Then, the datum of the time when the task has actually passed the checkpoint is acquired, and a comparison of the acquired time with the previously set budget elapsed time of that checkpoint is made, whereby the progress is judged. In the task execution control, the frequency of clocks and voltage are changed. For controlling the task execution on the multiprocessor, a shared-resource controller module which controls a resource shared by two or more processors is provided; the shared-resource controller module receives notifications of the progress of tasks from the processors, and performs control so that the priority to use a shared resource for the processor larger in delay of the progress is raised.

Second, as the advantage, the restriction on the scope of application of an application software program is eliminated by the effect as described above. Specifically, as any program can be applied, the effectiveness of enhancement of performance and reduction in power consumption can be made greater. As to image compression programs, which have been targeted in the art, it becomes possible to grasp the progress in units of smaller subprograms. This enables control in an earlier stage in the course of execution, and thus a situation such that it is too late to take measures against a problem can be avoided, and the feasibilities of enhancement of performance and reduction in power consumption are increased.

Now, an example of application of the invention to a task simulator working on a multiprocessor will be described.

The simulator moves ahead the time of a processor with a task loaded thereon according to the progress of the task thereby to simulate not only the function but also the time. However, when two or more processors communicate mutually, the difference in time between processors can prevent exact real-time monitoring of the progress of the task, causing inconsistencies in the task operation. To cope with this, the simulator performs task control to recognize the difference in time between processors, and make the processors coincide in time mutually.

### <Primary Configuration of Simulator>

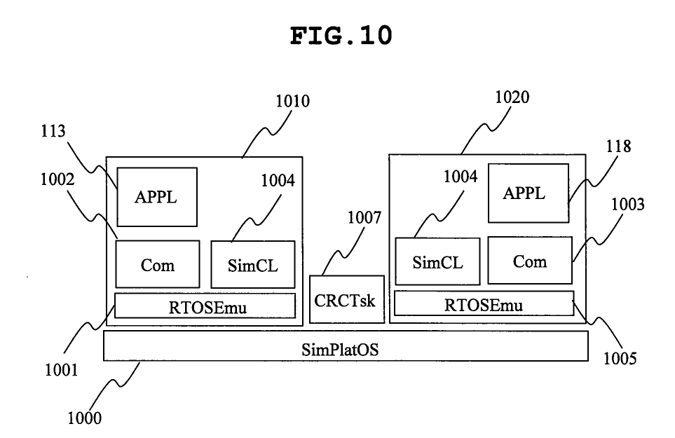

FIG. 10 shows an example of the configuration of the simulator.

The simulator refers to a previously set time required for execution and uses the time to simulate not only a function but also an elapsed time without using any hardware simulator.

First, the outline of the whole simulator will be described. The simulator works on a platform OS 1000.

The reference numerals 1010 and 1020 denote groups of tasks working on the CPUs 100 and 101 of the processors which operate in parallel. Tasks running on the CPUs 100 and 101 need operating independently of and in parallel with each other, and therefore the task groups 1010 and 1020 must each include at least one task for the platform OS 1000. The media for communication between the CPUs 100 and 101 need to operate independently of and in parallel with these tasks. Therefore, the simulator includes a CRCTsk 1007 as a task for simulating the media. Incidentally, the abbreviation CRC stands for Communication Resource Control. The CRCTsk 1007 corresponds to, as actual hardware, a combination of the BUS_ARB 104 and the shared memory (CM) 105, interrupt controller (IntC) 107, Timer 108 and other component, which are connected to the BUS_ARB 104. As the CRCTsk 1007 accepts communication from two or more processors, the CRCTsk 1007 must include the function of synchronizing the timing of data reception to achieve a consistent data acceptance.

The groups of tasks 1010 and 1020 have the same configuration. Therefore, only the inside configuration of the group of tasks 1010 will be described here.

The tasks of the task group 1010 are composed of an emulator (RTOSEmu) 1001 of the RTOS 111, and three tasks working on the emulator 1001. The three tasks are the APPL 113, a dedicated task (COM) 1002 which receives data from the task group 1020 through the task (CRCTsk) 1007, and a task controller (SimCL) 1004 for the simulator. Incidentally, the COM 1002 may be also loaded on the real processor as shown in FIG. 1. The COM 1002 is essential in this embodiment of the simulator, and therefore it is herein adopted as a constituent feature particularly.

The task group is arranged so that the APPL 113 and dedicated task (COM) 1002 are loaded on the emulator (RTOSEmu) 1001. However, an emulator of a type which translates a service call from the RTOSEmu 1001 into a service call of the platform OS 1000 and executes the service call, does not have the RTOSEmu 1001, and such type of emulator is arranged so that it holds a translation table in the APPL 113 or the COM 1002.

### <Time Management and Task Control of the Processor>

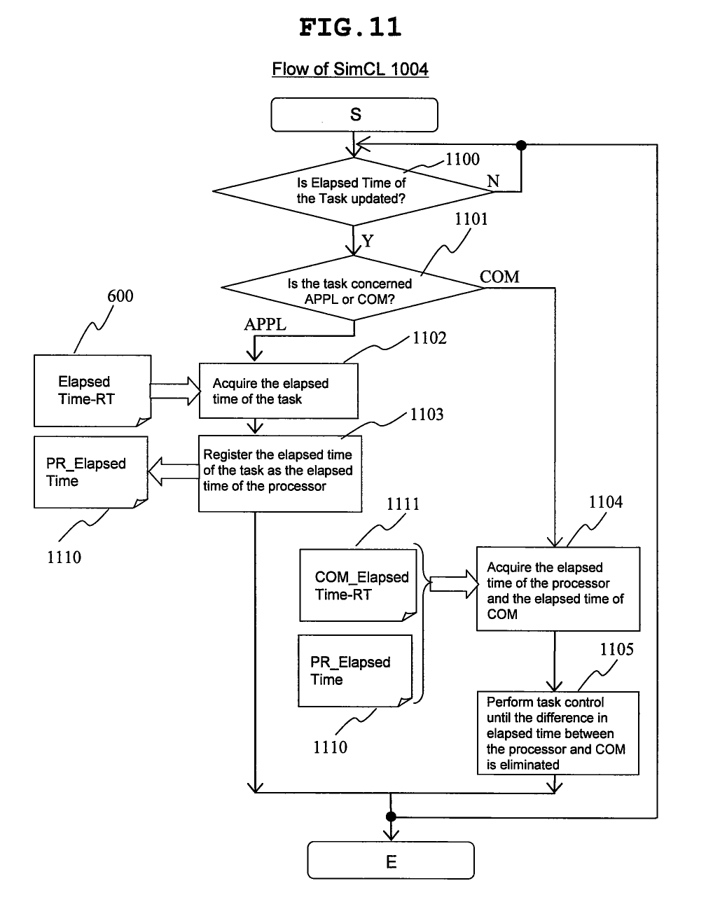

As in FIG. 11, in Step 1100, it is judged whether or not the task-progress registration process 400, which has been described with reference to FIG. 6B, is conducted. When no bit is updated, this process is performed repeatedly. The flowchart of FIG. 6B is the same as that of the operation of the simulator. However, the elapsed time is to be acquired on the simulator, which is gained following the steps of: previously holding a processing time between a preceding checkpoint and the current checkpoint in a table in advance; and adding the held processing time to the elapsed time of the preceding checkpoint. As for this process, attention should be paid to that the burying step in the task-progress registration process, i.e. the step of burying a checkpoint need to be set at the point of termination of each branch when the process varies from branch to branch like the Second and Third processes shown in FIG. 4. This is because the elapsed time is determined by addition of the budget time of the preceding process, and the elapsed time is not settled unless the process is determined. In this example, an additionally prepared table is referred to in acquisition of the elapsed time. However, the processing time may be buried in an application software program to calculate the elapsed time in it.

In Step 1101, it is judged whether the task which has undergone the update is the APPL 113 or COM 1002, based on the updated table. When the task concerned is judged to be the APPL 113, in a combination of Steps 1102 and 1103, the time of the processor is moved ahead. However, when the task is judged to be the COM 1002, the task controller proceeds to Step 1104. In moving the time, first in Step 1102, the elapsed time of the latest checkpoint is acquired from the ElapsedTime-RT 600. The elapsed time thus acquired is registered in a table (PR_Elapsed Time) 1101 as the elapsed time of the processor, i.e. simulator's time. This table is for registering only the time of the processor, and its detailed description is omitted here.

Next, when the COM 1002 updates the elapsed time, it receives the elapsed time of the processor 101 and then performs the update. In Step 1104, the elapsed time of the processor concerned is acquired from PR_Elapsed Time 1110, and the elapsed time of the COM is acquired from COM_Elapsed Time-RT 1111. The COM_Elapsed Time-RT is also for registering only the time of the processor, and its detailed description is omitted here. As the processor and COM 1002 are different in elapsed time, it is required to match the two kinds of elapsed time thus acquired to each other. Hence, in Step 1105, execution of the task is controlled.

### <Details of Task Control>

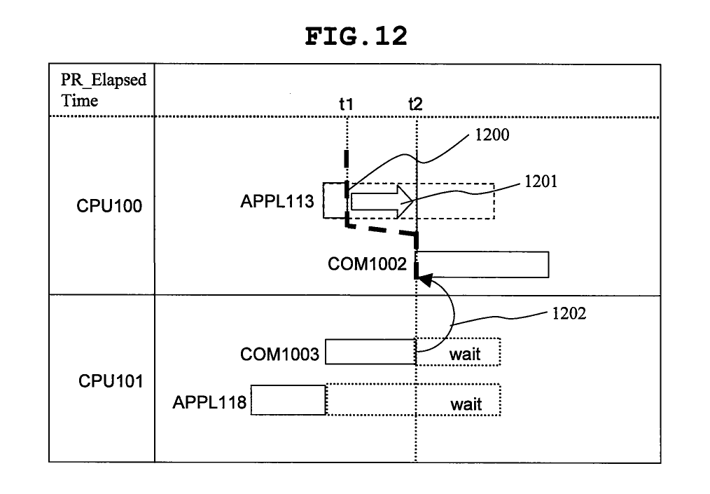

FIGS. 12 to 14 are illustrations each showing the task controls performed on the APPL 113 and COM 1002 when the COM 1002 has registered the processor's elapsed time of the CPU 101 in the COM_Elapsed Time-RT 1111, which are separated into parts according to the relation of the processor's elapsed time between the CPUs 100 and 101 and the state of the APPL 1113.

First, the notations commonly used in FIGS. 12 to 14 will be described. In the uppermost area of each drawing are shown the current elapsed times of the processors CPU100 and CPU101. The reference character t1 denotes the elapsed time of the CPU 100, and t2 denotes the elapsed time of the CPU 101. In the second area from above are shown the current states of the tasks working on the CPU 100, i.e. APPL 113 and COM 1002, and the control which the task controller (SimCL) 1004 will perform after that by an arrow 1201, etc. The broken line 1200 shows the current state of the task. For example, in FIG. 12, the APPL 113 is at the elapsed time t1 of the CPU 100, and the COM 1002 is at the elapsed time t2 of the CPU 101. In the lowermost area are shown the states of the tasks at the time when the COM 1003 of the processor of the CPU 101 performs data transfer. At the processor time t2, the tasks are waiting. The data is transferred from the COM 1003 to the COM 1002 through a bus as shown by the arrow 1202. While the transfer through the bus needs a length of time in fact, the time has no connection with the contents hereof, the time for bus transfer is ignored. Of Course, the bus transfer may be taken into account.

Next, the differences among the cases and task control will be described.

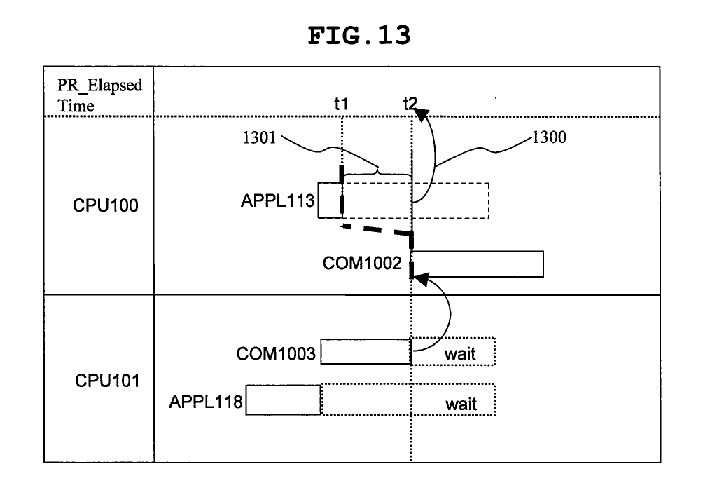

In the cases shown in FIGS. 12 and 13, the elapsed time t1 of the CPU 100 is shorter than the elapsed time t2 of the CPU 101, and in other words, the CPU 100 is delayed in time. In the case shown by FIG. 12, the APPL 113 stays in Running state or Ready state. In the case shown by FIG. 13, the APPL 113 is stopped in Wait state or Sleep state.

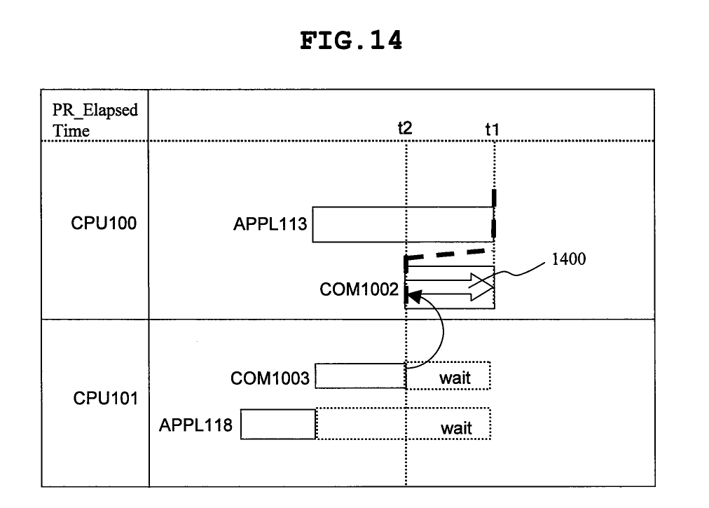

In the case shown by FIG. 14, t1 is larger than t2, and in other words, the CPU 100 is faster in time.

The details of the task control in the cases will be described below.

(1) First Case, where t1<t2 and APPL 113 is in Ready or Running State.

In this case, the COM is brought to Sleep state, and the APPL 113 is executed until t1 and t2 are made equal to each other as shown by the arrow 1201. When the APPL 113 is in Ready state, the COM goes into Sleep state, whereby execution of the APPL 113 is started. When t1 and t2 are made equal to each other, the COM is brought back to its initial state.

(2) Second Case, where t1<t2, and APPL 113 is Stopped.

In this case, as the APPL 113 will remain stopped for a time period 1301 until the time t1 reaches the time t2, the COM is bought to Sleep state and the elapsed time of the CPU 100 in the PR_Elapsed Time 1110 is forced to move forward to the time t2. It is also recorded somewhere that the APPL 113 is kept stopped for the time period 1301 because of the function of monitoring the state which the simulator has. The detailed description on this is omitted here because this has no connection with the contents hereof. After that, the COM is brought back to its initial state.

(3) Third Case, where t1>=t2.

In this case, as the APPL 113 does not need the data received by the COM until t1, the participation of processing by the COM is small. As shown by the arrow 1400, the COM goes ahead with processing with the time kept at t2. Also, the APPL 113 is executed as in the prior situation.

The agreement in time between the processors can be achieved at the time when the APPL 113 sends data to the CPU 101 and thus a coincidence between t1 and t2 occurs. At the time, the time data is sent to the COM.

While the invention made by the inventor has been described above specifically, the invention is not so limited. It is needless to say that various changes and modifications may be made without departing from the subject matter hereof.

In the above description, the invention made by the inventor has been described mainly focusing on the case where the invention is applied to a multiprocessor system, which is an applicable field hereof and makes a background hereof. However, the invention is not so limited, and it is applicable to semiconductor integrated circuits widely.

What is claimed is:

1. A task control method for controlling application software tasks with checkpoints previously buried therein when a multiprocessor device having processors executes the application software tasks, comprising the steps of:
using the checkpoints to make an inquiry about passed one of the checkpoints in each of the application software tasks in course of execution thereof;
judging progress of each of the application software tasks based on the current passed checkpoint identified as a result of the inquiry, and a passed budget corresponding to the passed checkpoint; and
controlling a resource shared by the application tasks and setting a new passed budget based on a result of the judgment.

2. The task control method according to claim 1, wherein the inquiry addressed to each of application software tasks is made at a time when an estimated elapsed time of a certain checkpoint elapses, and
information notified as a result of the inquiry includes information of the checkpoint which the application software task is currently passing, and information of time of passing the checkpoint.

3. The task control method according to claim 1, wherein when the application software task larger in degree of delay than the other application software tasks is controlled, the application software tasks are separated into a part for controlling a parameter used only by predetermined one of the processors and a part for controlling a resource shared by more than one processor, and
the predetermined processor performs task control on the part for controlling the parameter, and a module independent of the more than one processor performs control on the part for controlling the shared resource.

4. The task control method according to claim 1, wherein the judgment of progress is performed using a budget value of elapsed time which has elapsed before termination of each task, a budget value of elapsed time of the just passed checkpoint, and an actual elapsed time of the just passed checkpoint.

5. The task control method according to claim 3, wherein the task control performed by the predetermined processor includes transferring a budget value of elapsed time which has elapsed before termination of each of the application software tasks, a budget value of elapsed time of the just passed checkpoint and an actual elapsed time of the just passed checkpoint to the module which performs control on the shared resource together with a processor ID and new resource information created as a result of controlling a local resource.

6. The task control method according to claim 3, further comprising the step of changing a priority of the application software task in association with the shared resource or the processor with the task loaded thereon so that the priority of the application software task more difficult to make up for delay or the processor with the task loaded thereon is made higher.

7. The task control method according to claim 3, further comprising, as a means for making higher the priority of the application software task more difficult to make up for delay or the processor with the application software task loaded thereon, the step of making higher the priority of the task higher in ratios of B to A and C to B or the priority of the processor with the task loaded thereon,
where A denotes a budget value of elapsed time which has elapsed before termination of each task, B denotes a budget value of elapsed time of the just passed checkpoint, and C denotes an actual elapsed time of the just passed checkpoint.

8. A semiconductor integrated circuit, comprising:
a memory storing a task control program which realizes a task control method for controlling application software tasks when a processor device having processors executes the tasks with checkpoints previously buried therein, the method including the steps of
using the checkpoints to make an inquiry about passed one of the checkpoints in each task in course of execution thereof,
judging progress of each task based on the current passed checkpoint identified as a result of the inquiry, and a passed budget corresponding to the passed checkpoint, and
based on a result of the judgment, controlling a resource shared by the tasks and setting a new passed budget; and
a CPU capable of executing the task control program stored in the memory.
